(19) United States
(12) Patent Application Publication
(10) Pub. No.: US 2012/0072509 A1
(43) Pub. Date: Mar. 22, 2012

(54) METHOD AND SYSTEM FOR INTEGRATING APPLICATIONS WITHIN A WORK PROCESS

(76) Inventor: Lloyd George BOOTH, Mead, CO (US)

(21) Appl. No.: 13/225,536

(22) Filed: Sep. 5, 2011

Related U.S. Application Data
(60) Provisional application No. 61/379,845, filed on Sep. 3, 2010.

(51) Int. Cl. G06F 9/46; G06F 15/16

(52) U.S. Cl. 709/206; 719/313

(57) ABSTRACT

A system and method for implementing a work process having a plurality of required activities. The system includes a database configured to receive and supply activity data in a first format, and an enterprise application that performs one or more of the required activities and supplies its activity data to the database in the first format. The system also includes a stand-alone activity application having an original set of function controls which are not congruent with the enterprise application, and which normally performs another of the required activities while storing its activity data in a second format. The system further includes a bridging application which launches and embeds the activity application within the bridging application, changes the original set of function controls into a modified set of function controls that are congruent with the enterprise application, and communicates the activity data from the activity application to the database.

### RELATED APPLICATIONS

This application claims the benefit of U.S. Provisional Patent Application No. 61/379,845, filed Sep. 3, 2010 and entitled “Method and System for Integrating Applications with a Work Flow Process,” which is incorporated by reference in its entirety herein.

### BACKGROUND

1. Field

The present invention relates to implementation of a work process, and more specifically to the integration of software applications through one or more conductor layers and a universal data model for purposes of implementing a specific work process.

2. The Technology

Many businesses implement a dedicated work process, also known as a work flow process, that outlines tasks, steps or activities that need to be completed each and every time to fulfill a business requirement. For instance, in the retail automobile business, buyers often times take out automobile loans to finance all or a portion of a purchase. For standardization and efficiency, each and every loan process handled by the automobile dealer follows the same steps in order to finalize the loan. These steps are organized into a work process, such as 1) perform credit check; 2) loan application; 3) loan processing, etc.

Many times, the steps or activities to be performed in the work process are implemented through one or more software applications in order to more fully automate the process. Further, each step in the work process may be so complex such that entire industries have evolved just to handle business matters within that step. As such, it is conceivable that every step in the work process can be implemented through a separate and corresponding application.

A best-of-breed solution may be chosen by a business to implement a specific work process. For each step or activity in the work process, the business chooses between one or more third party application providers to find the corresponding application capable of supporting the completion of a corresponding step. As a result, two or more companies may provide software applications that support completion of two or more steps in a work process.

In the best-of-breed solution, two applications that were designed and created by different software development companies are typically incompatible. Namely, information from one application is presented in a format that is not understood by a second application, and vice versa. As such, these applications are separately and independently run, as information cannot easily be shared between the two applications. As such, when using both applications in a work process it can become a manual and burdensome process to transfer information from a first application to a second application. In particular, the information must be copied from the first application; the first application is then closed; the information is reformatted to a format supported by the second application; the reformatted information is copied and/or stored; the second application is opened; and the reformatted information is then imported into the second application. This burdensome best-of-breed solution is completed for every step of the work process using a different application.

A cradle-to-grave solution provides another way to implement a work process. In this solution, one software developer creates the different applications that support completion of each step of the work process. Because a single software developer creates each underlying application, information from one application is compatible with other applications. That is, information from one application can be transported to and used by another application without any reformatting, thus fully integrating all the applications.

While a cradle-to-grave solution elegantly solves the problem of integrating multiple and incompatible applications presented by the best-of-breed solution, the cradle-to-grave solution is expensive, typically costing ten times as much, or more, as a best-of-breed solution. In addition, one application from a cradle-to-grave solution that supports the completion of a single stage in a work process may not be as desirable to a customer, as another independent and third party application that provides the same support towards completion of the stage. For instance, the third party application may be designed by a software developer that only focuses on supporting the completion of that single stage, and as such has refined its solution in such a manner that is desired by most in the industry.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of an external bridging application system that is capable of integrating one or more applications within a work process, in accordance with one embodiment of the present invention.

FIG. 2 is an illustration of an external bridging application system that is capable of integrating one or more applications within a work process, in accordance with another embodiment of the present invention.

FIG. 3 is a flow diagram illustrating a method for implementing a work process with an external bridging application system used for integrating one or more activity applications, in accordance with another embodiment of the present invention.

FIGS. 4A-4B are illustrations of screen shots of a display of a representative stand-alone activity application operated as a separately executable program.

FIGS. 5A-5I are illustrations of screen shots of a display within an external bridging application system showing the integration of a representative activity application within a bridging application, in accordance with another embodiment of the present invention.

FIG. 6 is an illustration of an internal bridging application system that includes one or more bridging applications embedded within an enterprise application, with each bridging application dedicated to an embedded activity application, in accordance with another embodiment of the present invention.

FIG. 7 is an illustration of an internal bridging application system that includes a universal conductor layer and one or more bridging applications, and which system is capable of integrating one or more activity applications into an enterprise application, in accordance with another embodiment of the present invention.

FIG. 8 is a flow diagram illustrating a method for implementing a work process with an internal bridging application system used for integrating one or more activity applications within an enterprise application, in accordance with another embodiment of the present invention.

FIGS. 9A-9E are illustrations of screen shots of a display within an internal bridging application system showing the integration of representative activity applications and bridging applications within an enterprise application, in accordance with another embodiment of the present invention.

### DETAILED DESCRIPTION

Reference will now be made in more detail to the preferred embodiments of the present invention for integrating various applications while implementing a work process. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention.

Accordingly, embodiments of the present invention provide for the integration of two or more applications, such as an enterprise application and a task or activity application, within a best-of-breed solution used to implement the work process, wherein the best-of-breed solution includes two or more incompatible applications that may be created by different software design companies. Other embodiments of the present invention provide for the integration of one or more applications, such as an enterprise application and a task or activity application, with a core database, such that information stored in the core database is usable by the one or more applications.

Still other embodiments provide the above advantages and further are capable of implementing a system for integrating two or more applications supported by a universal data model. The universal data model provides additional advantages including an extensible database, the ability to share data with other parties/applications, and the ability to understand the state of the data (i.e., that the data is not static, and is constantly changing and evolving) for purposes of aligning the data with various applications so that they all use information in the same state. The concept of a bridging application or conductor layer described in embodiments of the present invention utilizes the universal data model, so that even though there may be multiple different applications supporting a single work process, each of which may have a supporting and dedicated data store and/or database, the bridging application or conductor layer is able to take information that is shared and convert that information into the universal data model format, which data can then be stored in a database. The universal data model format may or may not be compatible with the various applications and their supporting platforms. If the universal data model format is not compatible with a particular application, a bridging application supporting that application is able to format and reformat information so that the application is able to use shared information and send information it generates in a form suitable for use by other applications.

### Notation and Nomenclature

Embodiments of the present invention can be implemented with software programs or applications for executing commands and processing data through a computer system. In one aspect, the computer system can be one or more personal computers, notebook computers, server computers, mainframes, networked computers (e.g., router), handheld computers, personal digital assistants, workstations, and the like, and can include both the physical hardware device and any firmware, operating system programs, networking programs, and additional software programs, etc., which may be installed and operating on the one or more devices.

Other embodiments may be implemented through specialized hardware for purposes of integrating two or more applications within a best-of-breed solution used to implement a work process. This program or its corresponding hardware implementation is operable for enabling the integration of one or more applications supporting the completion or implementation of a work process. In one embodiment, the computer system includes a processor coupled to a bus and memory storage coupled to the bus. The memory storage can be volatile or non-volatile and can include removable storage media. The computer system can also include a display as well as provisions for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “providing,” “accessing,” “storing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the Application, the term “database” is used to describe a location for storing information or data, and/or a mechanism for storing information or data. As such, “database” is interchangeable with the following terms: storage, data store, etc.

### Work Process

Throughout this Application, reference is made to a work process, also known as a work flow process. In general, a work process describes the various stages, and the tasks, steps or activities within those stages that are required to be completed to fulfill a business need. The same work process can be used each and every time the same business need arises. Execution of the work process may occur in a linear fashion, such that stages are completed in sequential order, or a non-linear fashion, such that stages may be completed in any order and that two or more stages may be completed simultaneously. In that manner, it is ensured that an efficient process is implemented to fulfill the business need, and furthermore, by following the work process every step within every stage is ensured to be completed.

For instance, a work process can be used by a mortgage company every time a real estate mortgage is applied for by a potential home buyer. This work process describes each and every stage or activity contemplated by the mortgage company to take in the request from a buyer, such as, process the loan, order credit report(s), perform a title search, complete the loan, and arrange for closing, retain the customer buyer, among other steps. Each and every stage or activity may be supported by a different software application, otherwise referred to as an “activity application.” As examples, it is contemplated that the various stages in a mortgage processing work process which may require the use of an activity application specific to that stage may include the following: 1) loan processing; 2) loan production; 3) accounting; 4) document preparation; 5) product and pricing; 6) customer retention management (CRM); and 7) marketing or secondary marketing, etc.

For purposes of illustration, the work process that can be used within the real estate mortgage industry is described throughout this Application to illustrate methods and systems for integration of one or more applications for purposes of implementing a work process. However, it is intended that the methods and systems described herein are capable of integrating one or more applications for purposes of implementing any work process, in embodiments of the present invention.

### External Bridging Application System and Method

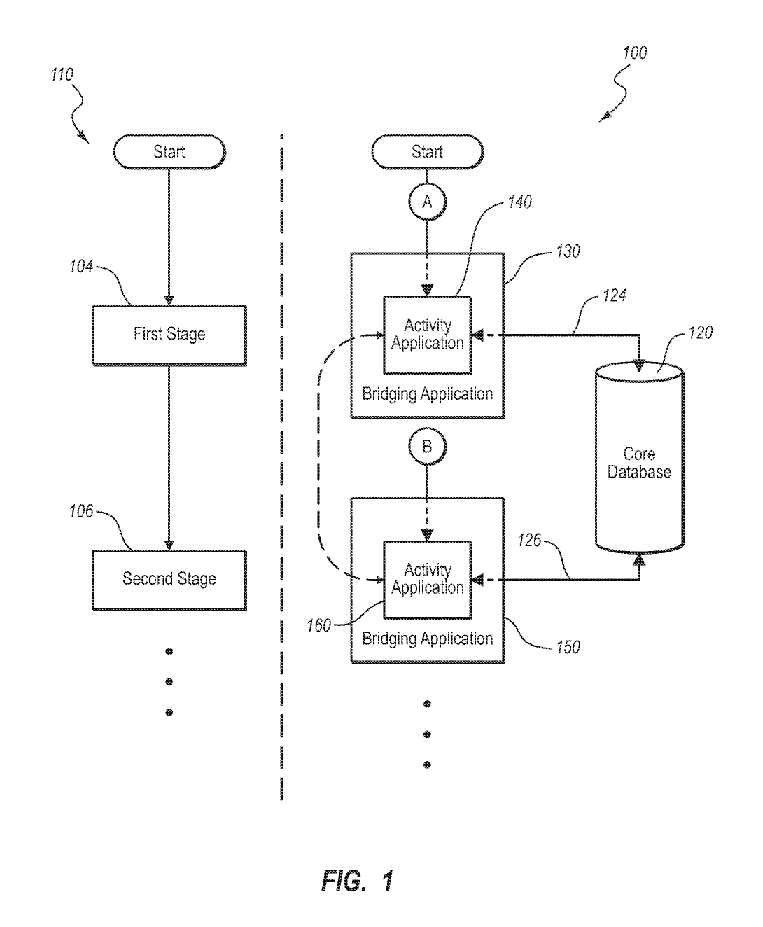

FIG. 1 is an illustration of an external bridging application system 100 that is capable of integrating one or more applications within a work process 110, in accordance with one embodiment of the present invention. The external bridging application system 100 allows different applications associated with information of varying formats to communicate with each other, in one embodiment.

As shown in FIG. 1, the system 100 includes a work process 110 comprising a plurality of stages to be performed. As previously described, the work process 110 includes one or more stages that are completed in order to fulfill a business need. For instance, within the mortgage industry, the various stages may include taking in a loan application as a first stage 104, processing the loan as a second stage 106, performing customer retention as a later stage, etc. By way of illustration, the work flow and its representative stages are shown to the left of the bolded line in FIG. 1. First and second stages 104, 106 of an indeterminate amount of stages are shown in FIG. 1. In many industries, a software activity application is created to perform the steps in each of the stages. The external bridging application system 100 allows for different applications that are incompatible to communicate and exchange information with each other.

System 100 also includes a first activity application 140 that is executed by a computing resource. The first activity application 140 is implemented to complete or help perform the first stage 104 in the plurality of stages 110. As shown in FIG. 1, the first activity application 140 is lined up with the first stage 104 of the work flow to signify their relationship. In the example provided above, the first stage 104 may be the loan application process, and the first activity application 140 is used by the mortgage broker to gather personal and financial information about the borrowers.

System 100 also includes a first bridging application 130 for providing access to the first activity application 140. As shown in FIG. 1, the first bridging application 130 can fully encapsulate or embed the first activity application 140 so that all communication with the first activity application 140 must go through the first bridging application 130. For example, the first activity application 140 can be embedded as a process object within the first bridging application 130. In addition, the first bridging application 130 can also reformat the activity information 124 delivered to the first activity application 140 into a format supported by the first activity application, and can reformat information 124 delivered from the first activity application into a common, or universal, format.

Within the first bridging application 130 the first activity application 140 can reside in its full form with its original set of function controls and features. However, the bridging application 130 is also able to customize the first activity application 140 in a manner that is more consistent or congruent with accomplishing the work process 110. More specifically, in one aspect the bridging application 130 is a powerful tool that is able to turn off various features or function controls within the first activity application 140 so that a user is unable to use those features. In addition, the bridging application 130 is also able to add new features or function controls to the first activity application 140 that otherwise would not be available to the user, or to add new features in substitution of the features previously rendered inaccessible.

The bridging application 130 is able to communicate directly with the first activity application 140 since it understands the commands, objects, and procedures, etc., understood by the first activity application 140. For instance, a process may be implemented to discover the necessary information used to communicate with the first activity application 140 that involves using at least one API (application programming interface) of an operating system for discovering information necessary for communicating with the first activity application. In one implementation, a Windows® API is used for discovering information about the first activity application. This process is used to discover information related to any conducted or bridged activity application, as described below, whether in external or internal form.

Also included in system 100 is a core database 120 that is in communication with the first bridging application 130. The core database 120 is for storing first activity information 124 from the first activity application 130 in a common format. More specifically, the bridging application 130 takes the activity information 124 from the activity application 130, reformats it into the common format, and thereafter delivers it to the core database 120 for storage and retrieval at a later date.

The core database 120 stores shared information in a common format so that various applications may access that information for their use. The information may be needed by various applications supporting a work process 110. The core database 120 provides a central repository for storing that information, or at least the information to be shared by numerous applications. While the various applications may be incompatible with each other, in that they are unable to pass along information between applications, by storing the information in a common format, bridging applications associated with each of the activity applications used in the work process 110 can be used to convert the activity information provided in the common format to a corresponding format compatible with each of the corresponding activity applications requesting the information.

In parallel, each of the applications may continue to store all or some of its processed information in its own dedicated storage in a native format. In that case, some information (e.g., shared information) may be stored in multiple data stores.

System 100 also includes a second activity application 160 that is executed by the computing resource, or by another computing resource also used for supporting the completion of the work process 110. The second activity application 160 is implemented to complete or help perform the second stage 106 in the plurality of stages. As shown in FIG. 1, the second activity application 160 is in line with the second stage 106 of the work flow, to signify their relationship. In the example provided above, the second stage 106 may be for loan processing.

System 100 also includes a second bridging application 150 for providing access to the second activity application 160. As shown in FIG. 1, the second bridging application 150 can fully encapsulate or embed the second activity application 160, so that all communication with the second application must go through the second bridging application 150. For example, the second activity application 160 can be embedded as a process object within the second bridging application 150. In addition, the second bridging application 150 can also reformat the activity information 126 delivered to the second activity application 160 into a format supported by the second activity application, and can reformat information 126 delivered from the second activity application into a common, or universal, format.

Within the second bridging application 150, the second activity application 160 can reside in its full form with its original set of function controls and features. However, the second bridging application 150 is also able to customize the second activity application 160 in a manner that is more consistent or congruent with accomplishing the work process 110. More specifically, in one aspect the second bridging application 150 is a powerful tool that is able to turn off various features or function controls within the second activity application 160 so that a user is unable to use those various features. In addition, the second bridging application 150 is able to add new features to the second activity application 160 that otherwise would not be available to the user, or add new features in substitution of the features previously rendered inaccessible.

Also, the core database 120 is in communication with the second bridging application 150. The core database 120 stores information or activity data 126 from the second activity application 160 in the common format. More specifically, the second bridging application 150 takes the information from the second activity application 160, reformats it into the common format, and thereafter delivers it to the core database 120 for storage and retrieval at a later date, and where it can be made accessible to either of the first or second activity applications 140, 160.

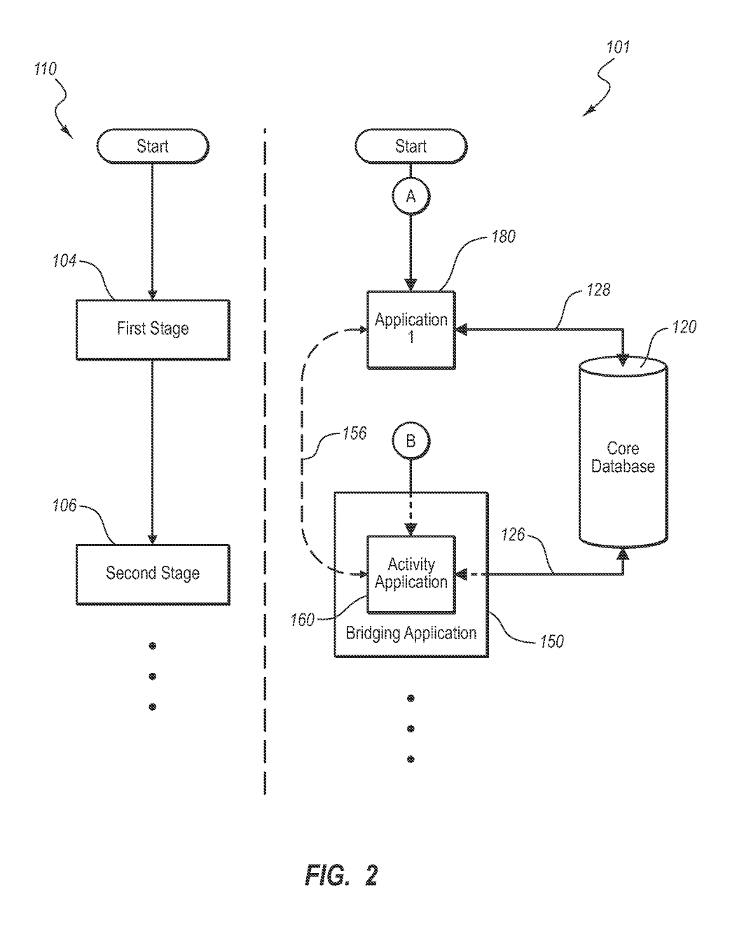

In another embodiment of the system 101 shown in FIG. 2, the second activity application 160 is used entirely, or in part, to support the first application 180, and which first application 180 may be an activity application or an enterprise application, as described in more detail below. For instance, the first application 180 may used to complete most or all of the stages in the work process 110, and as such, the core database 120 is native to the first application 180. That is, instead of having a separate core database that is independent of each of the applications, the core database is designed for direct use by the first application 180.

Nevertheless, with the present invention it may be desirable that instead of the core database 120 being dedicated solely to the first application 180, that the core database 120 is also configured to support all the applications, including the second activity application 160. In this case, consistent with packaging the core database 120 with the first application 180, the first application 180 may not be supported by a corresponding bridging application as it already controls most of the work process 110, and as such, information supporting the work process 110 is chosen to be in a format supported by the first application 180. In particular, information from the first application 180 is designed to be stored in the core database 120, whether it is used to accomplish the work process 110 or not. Information or activity data 128 generated by the first application 180 may be shared by the second activity application 160. Also, information or activity data 126 generated by the second activity application 160 may be shared by the first application 180. As such, however the second activity application is used, it is necessary to allow information from either the first or second applications to be shared with the other application.

For instance, the second activity application 160 can be used entirely, or in part, to support the first application 180. As an example, the second activity application 160 provides additional information 126 to support the first application 180 to complete one or more stages in the work process 110. Also, the second activity application 160 may provide additional information to independently complete one or more stages 106 in the work process 110. Information or activity data in its native format as generated by the second activity application 160 may be stored in a dedicated data storage supporting the second activity application 160. However, pertinent information that is shared with the first application 180, and possibly other applications, may be stored in the core database 120 that is associated with the first application 180. The shared information may also be simultaneously stored in the dedicated data storage associated with the second activity application 160.

System 101 allows for this sharing of information or activity data 126 through the second bridging application 150 and the core database 120, namely by converting information from the second activity application 160 to a format understood by the first application 180, so that information can be used by the first application 180 either directly through communications pathway 156, or through the core database 120. More specifically, the second bridging application 150 can reformat information delivered to the second activity application 160, either from the core database 120 through communications pathway 126 or directly from the first application 180 through communications pathway 156, into a format supported by the second activity application 160. The second bridging application 150 can also reformat information delivered from the second activity application 160 to the core database 120 into the common format, such as the native format of the first application 180.

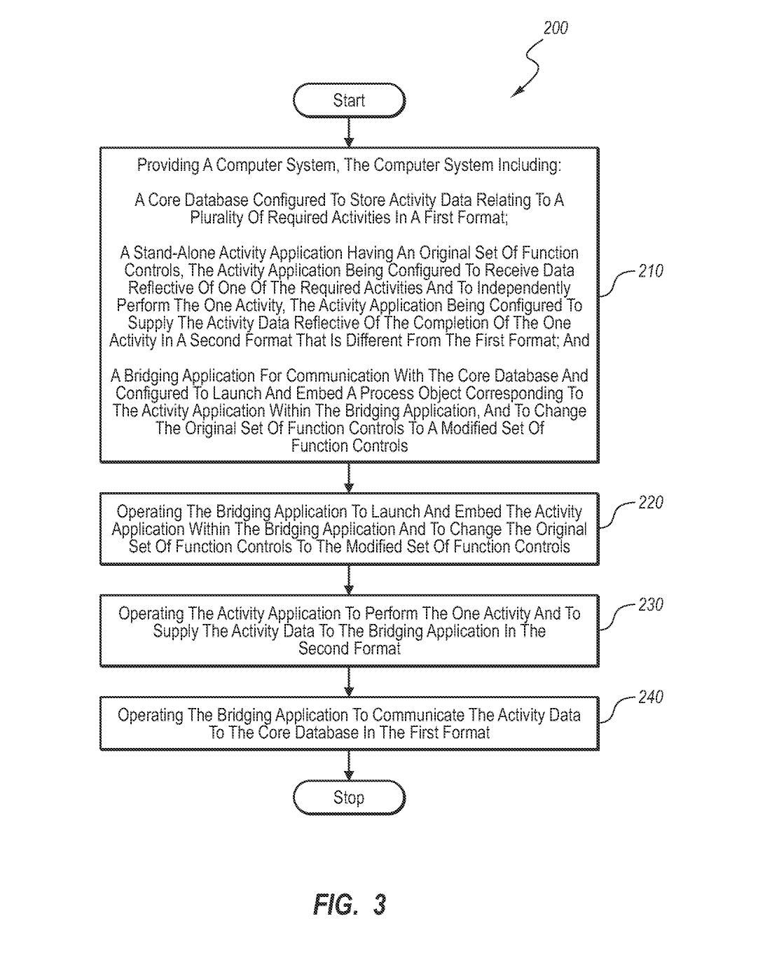

FIG. 3 is an illustration of a flow diagram illustrating a method 200 for implementing a work process having a plurality of required activities with an external bridging application system that is used for integrating one or more activity applications, in accordance with another embodiment of the present invention. In one aspect, the method of FIG. 3 can be implemented within the external bridging application systems 100 and 101 of FIG. 1 and FIG. 2, respectively. Embodiments of the present invention allow for the various stages in a work process to be completed in a sequential order, a non-linear order, a random order, simultaneously where multiple stages are performed simultaneously, or a combination of the above.

As shown in FIG. 3, the method 200 includes providing 210 a computer system that includes a core database configured to store activity data relating to the plurality of required activities in a first format, a stand-alone activity application having an original set of function controls and being configured to receive activity data reflective of one of the plurality of required activities and to independently perform the one activity, the activity application being configured to supply the activity data reflective of the completion of the one activity in a second format different from the first format, and a bridging application for communication with the core database and configured to launch and embed a process object corresponding to the activity application within the bridging application, and to change the original set of function controls to a modified set of function controls.

The method 200 also includes operating 220 the bridging application to launch and embed the activity application within the bridging application and to change the original set of function controls to the modified set of function controls.

The method 200 further includes operating 230 the activity application to perform the one activity and to supply the activity data to the bridging application in the second format, as well as operating 240 the bridging application to communicate the activity data to the core database in the first format.

In another embodiment (not illustrated) of a external bridging application system for performing a work process, a primary application provides the primary support to complete most or all of the stages. The core database supports the primary application. The first activity application is used to support the primary application, but may not be compatible with the primary application in that the first and primary application cannot communicate with each other. As such, the first bridging application is able to reformat information delivered to the first activity application into a format supported by the first application. Also, the first bridging application is able to reformat information delivered from the first activity application to the core database into the common format.

Also, a second activity application is provided that supports the completion of a second stage in the plurality of stages of the work process. The second activity application may be designed to step through the process needed to complete the individual steps necessary to complete the second stage in the work process. For instance, the second activity application may assist, control, or implement loan processing in a work flow related to the mortgage industry.

In addition, access to the second activity application is provided through a second bridging application. More specifically, all communication with the second activity application is conducted through the second bridging application. Further, the core database is in communication with the second bridging application. The core database stores information from the second activity application in a common format, or in a format that is suitable for use by another application, such as the first application, or the primary application.

Following the above example, the primary application may be used to implement most or all of the stages in the work process, and the second activity application provides additional support to the primary application, but may not be necessarily compatible with the primary application, in that the primary application and the second activity application cannot communicate with each other. As such, the second bridging application is able to reformat information delivered to the second activity application into a format supported by the second activity application. Also, the second bridging application is able to reformat information delivered from the second activity application to the core database into the common format.

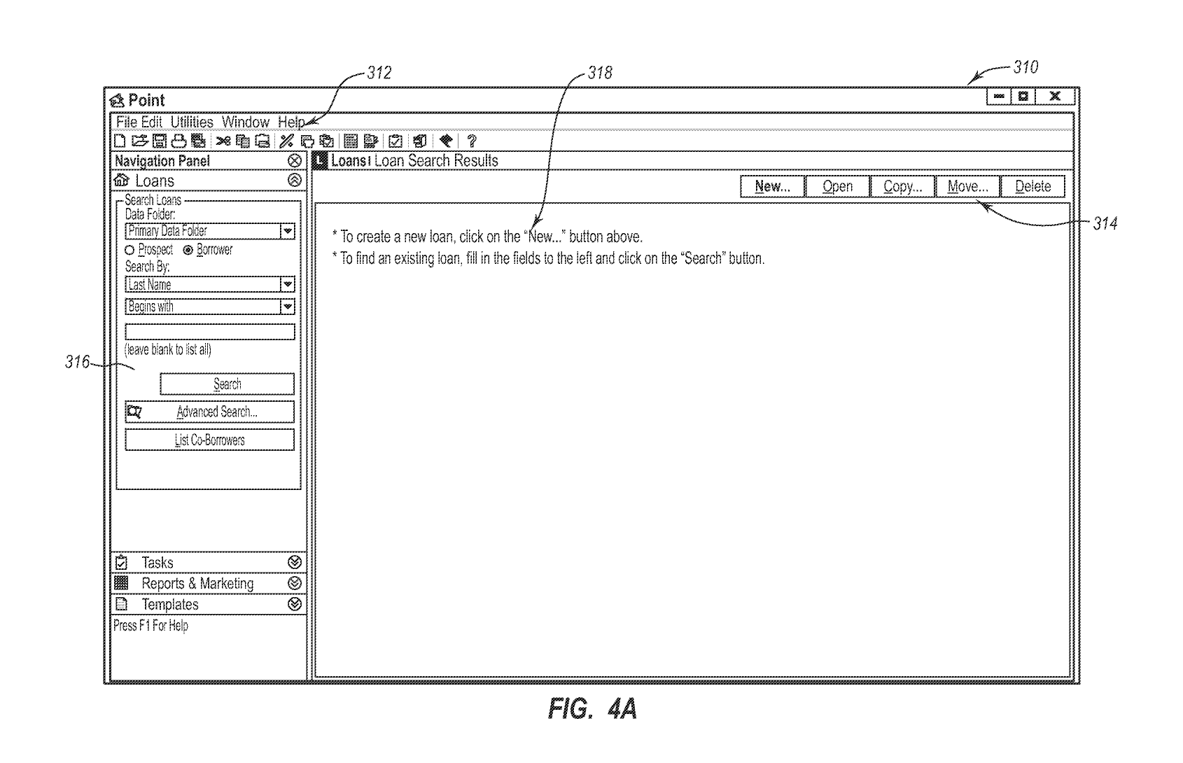

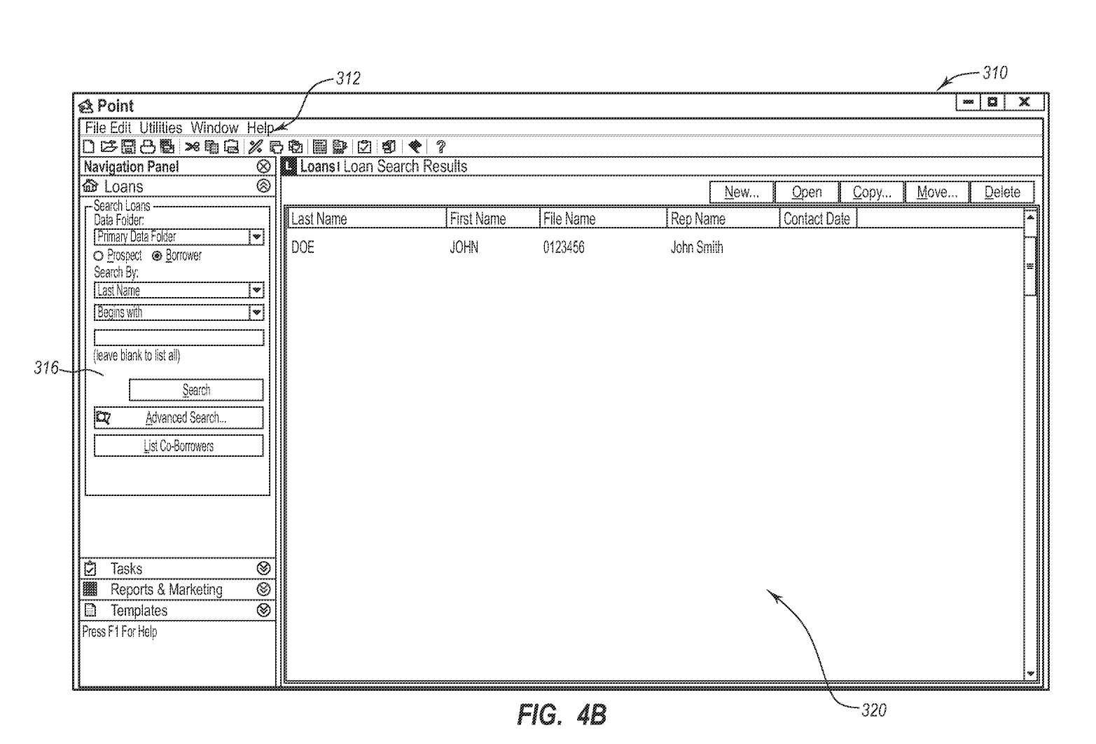

FIGS. 4A-4B are illustrations of screen shots of a display of a representative stand-alone activity application 310 operated as a separately executable program. For example, in one aspect the stand-alone or separately executable activity program can be a Point-of-Sale (“POS”) or Loan Origination Software (“LOS”) program for completing the application stage of a mortgage loan application process, such as the POINT® application program offered for sale by Calyx Software of San Jose, Calif.

As shown in FIG. 4A, the stand-alone activity application 310 incorporates an original set of function controls including, for example, a menu bar 312, a set of application-specific file management commands 314, a search command interface 316, and the functional controls for opening a new loan application 318. In certain circumstances, activating the function controls can allow the user access to certain features or capabilities which may not be compatible or congruent with the needs of the party performing the overall work process. For instance, selecting the search command interface 316 of FIG. 4A may provide a user with access to a listing of loan applications 320 for all the customers associated with a local office or facility, as shown in FIG. 4B. Such access may be inappropriate or even contrary to regulations in many cases, especially within a large office having many loan officers and loan processors accessing the same system and local database. Therefore, it may be needful or desirable to remove or at least modify the features and capabilities of the original set of control functions which, in this case, would operate to prevent unauthorized access to another party's loan documents.

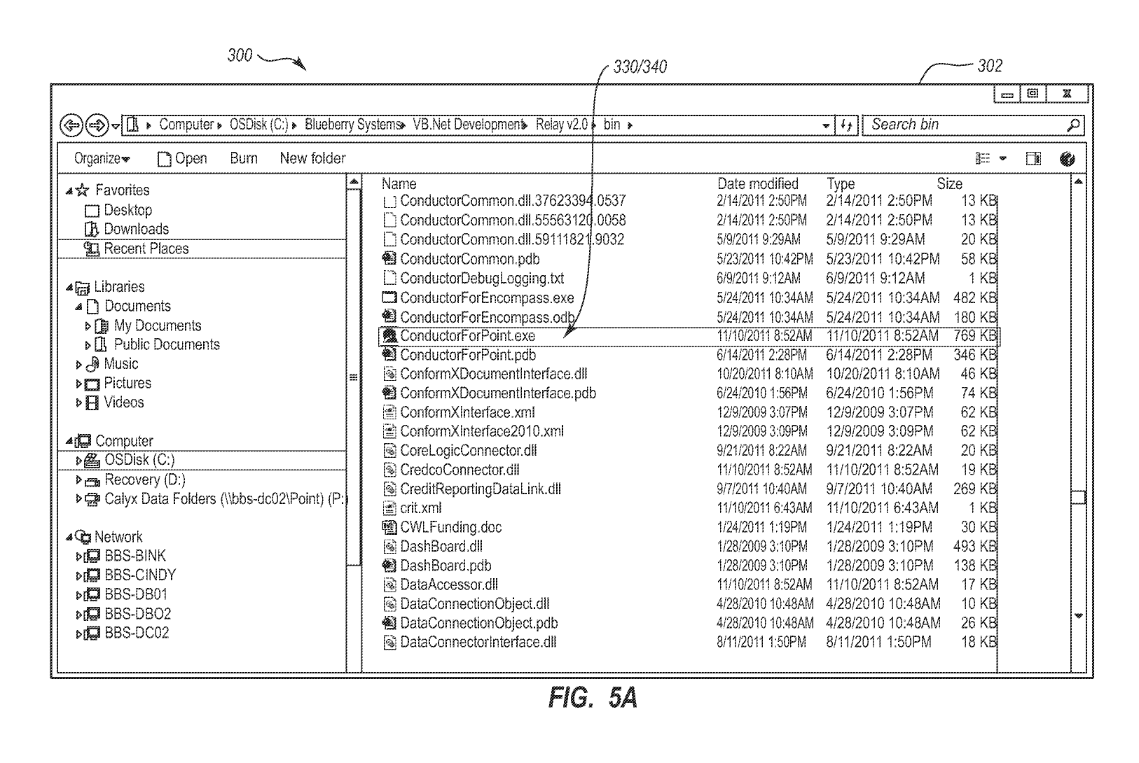

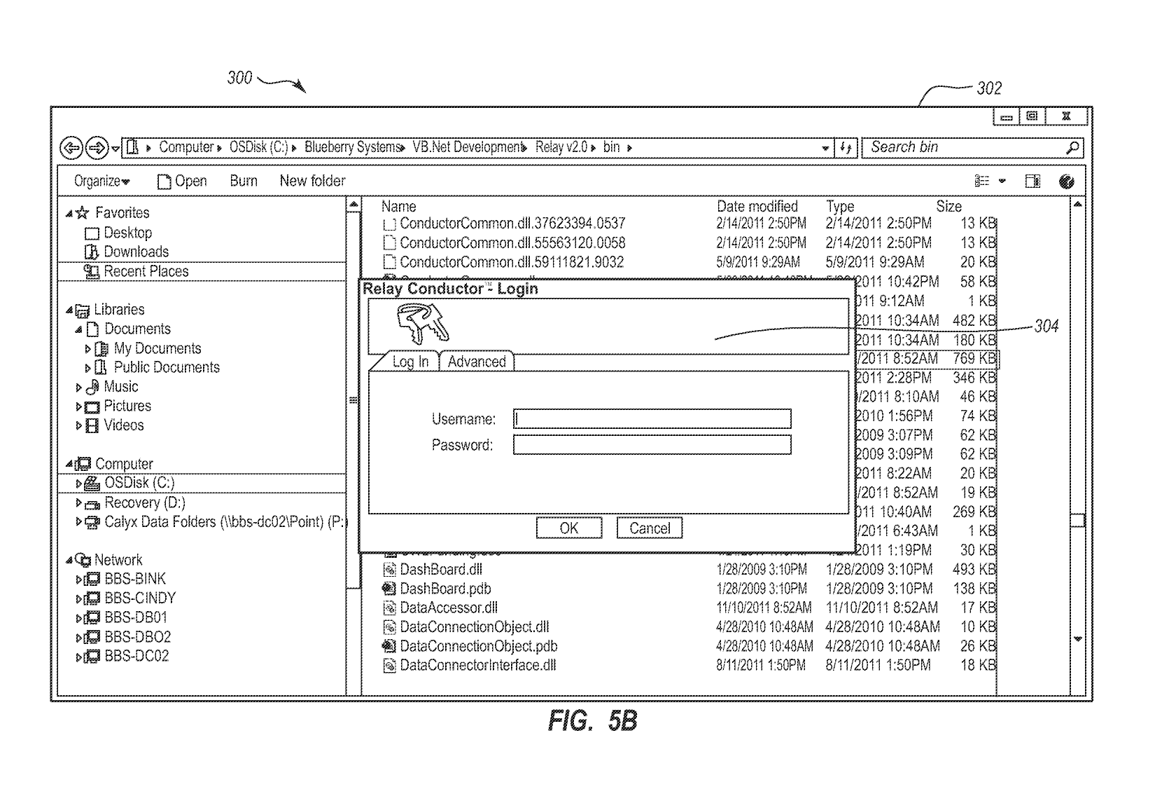

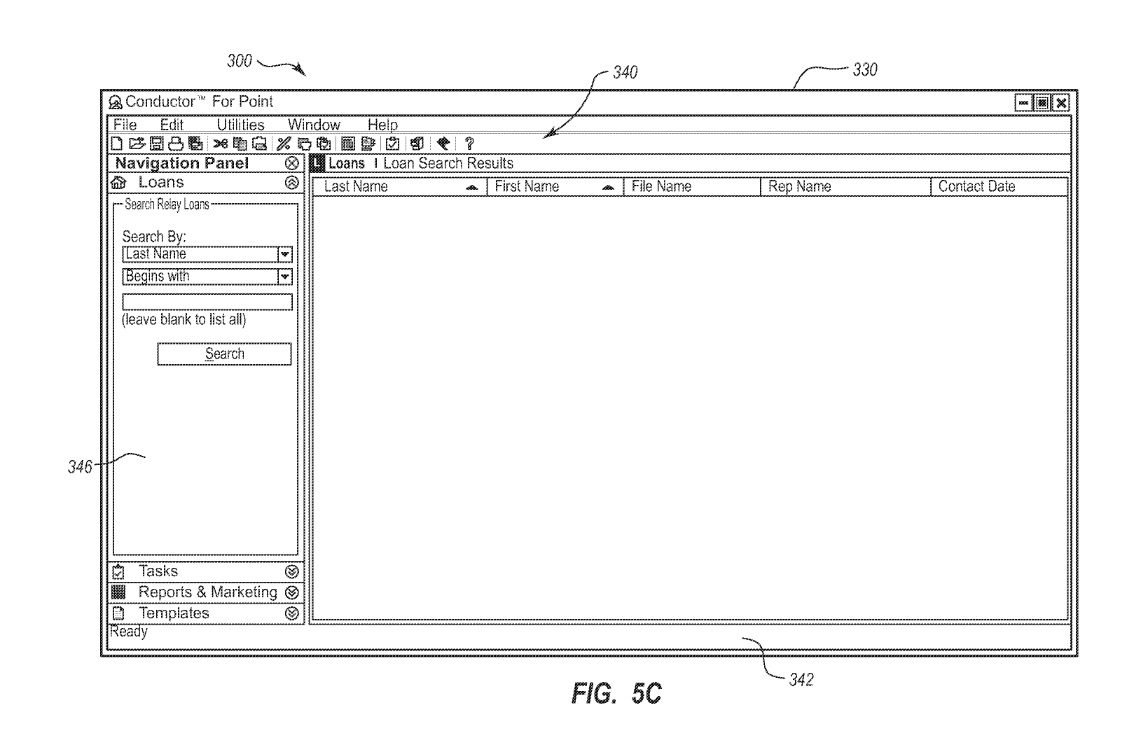

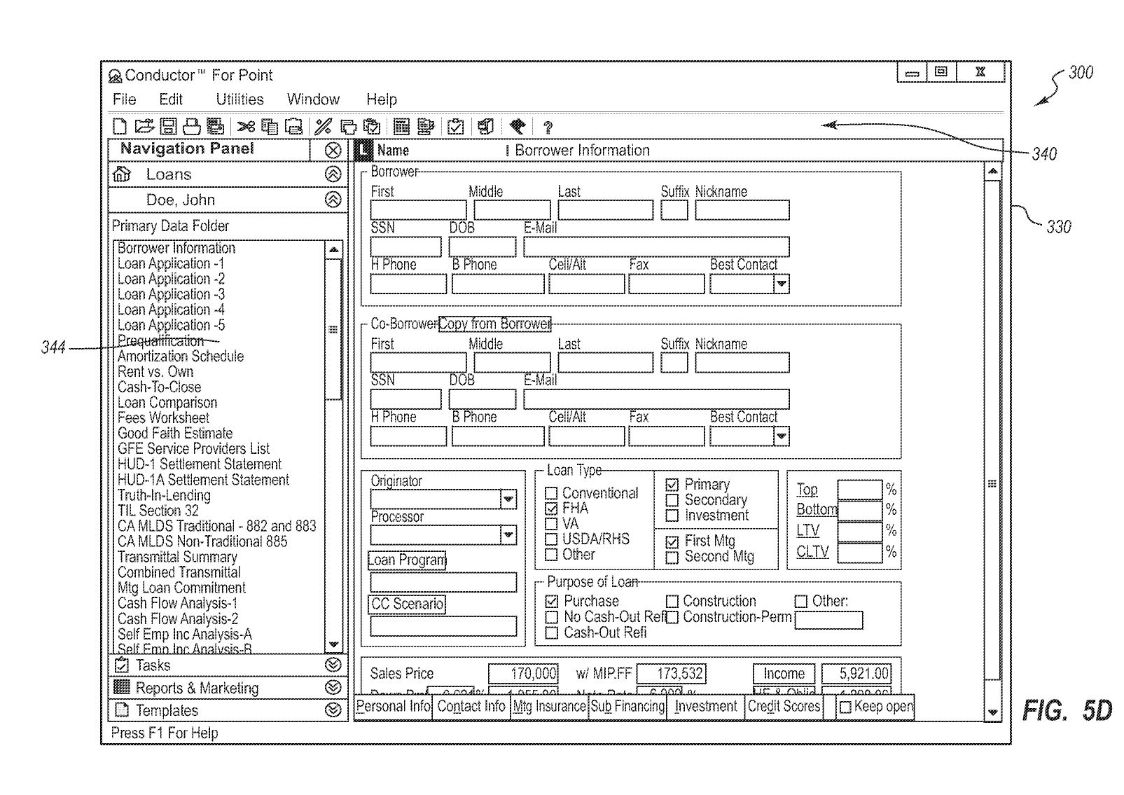

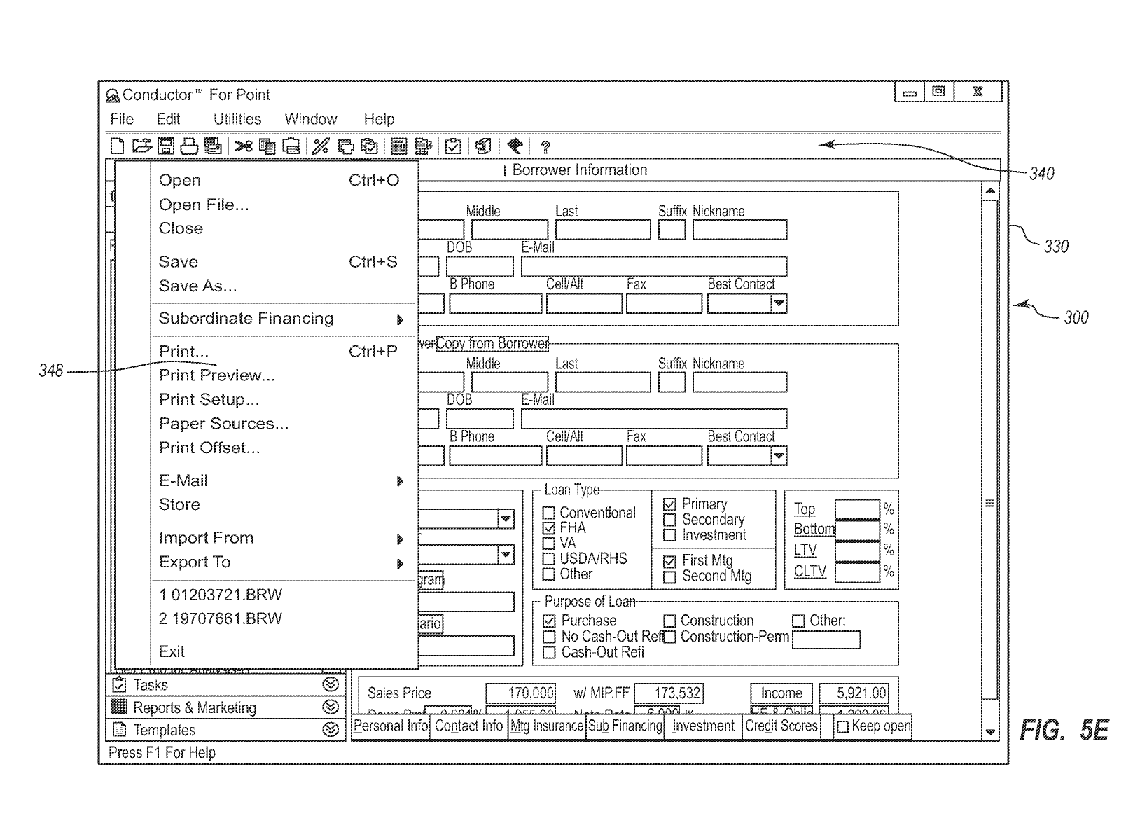

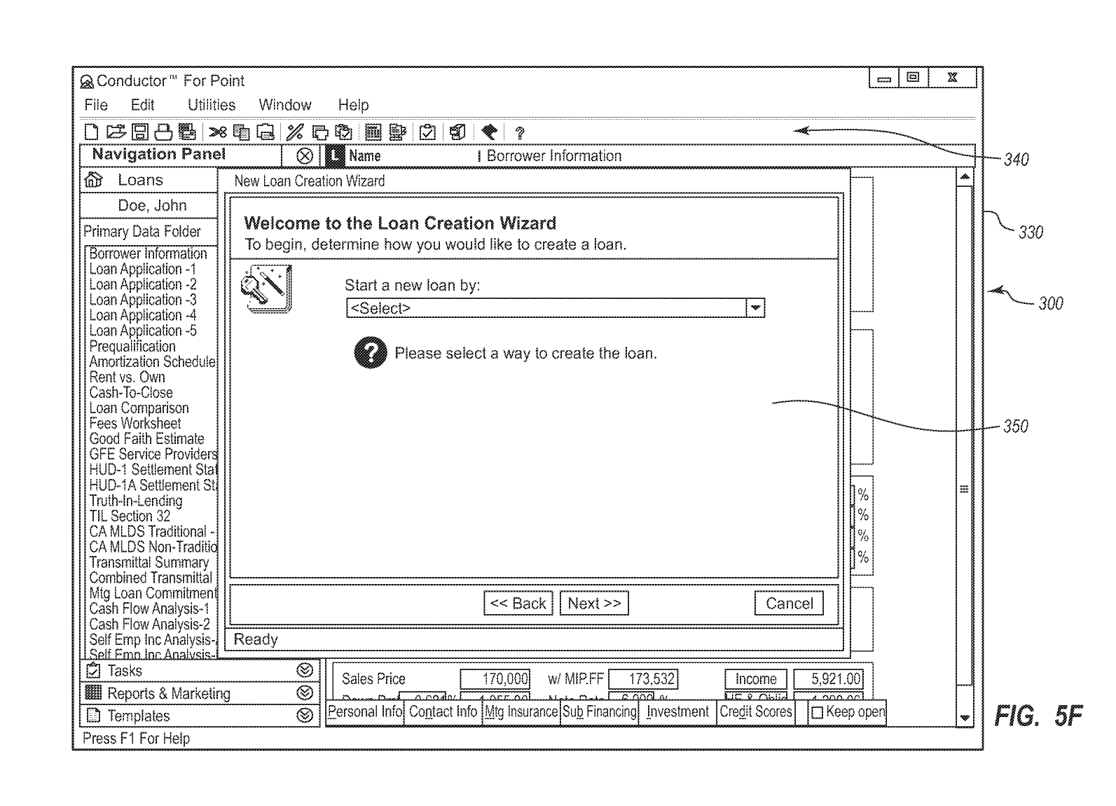

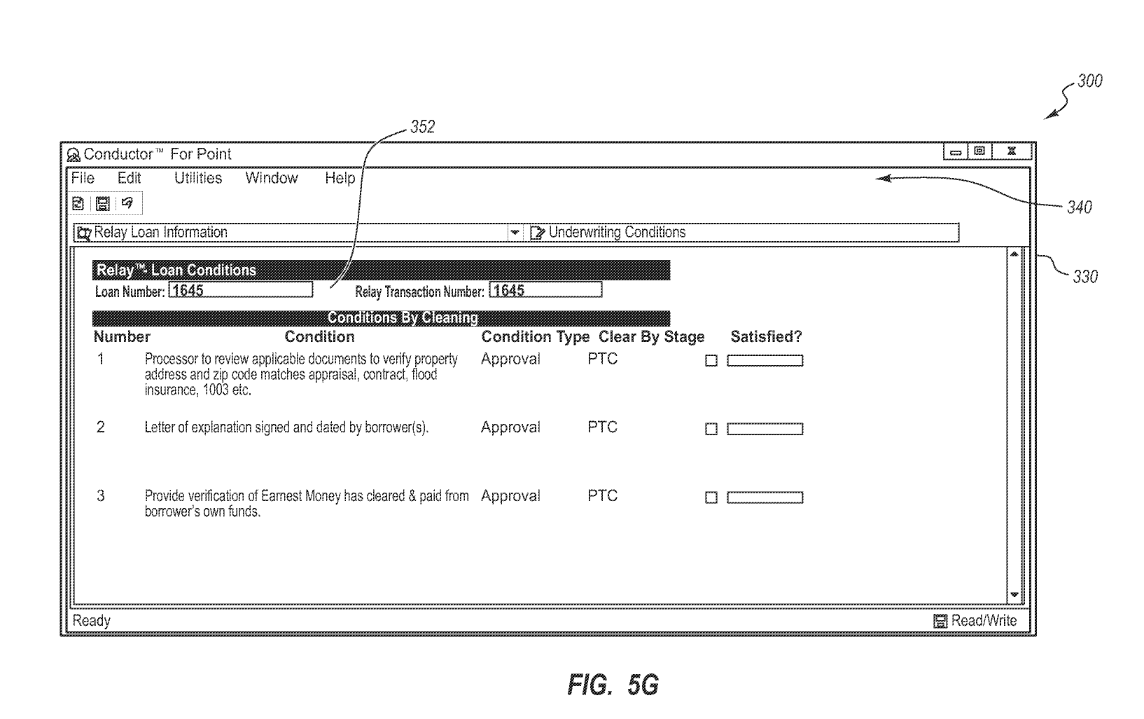

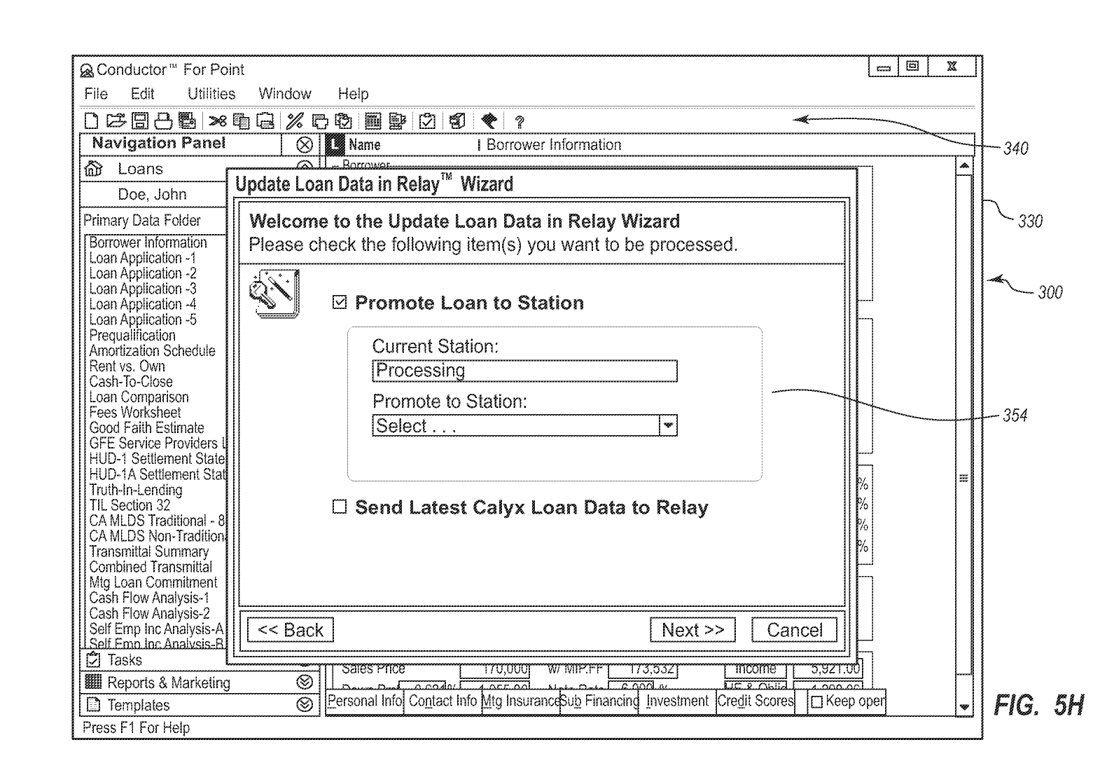

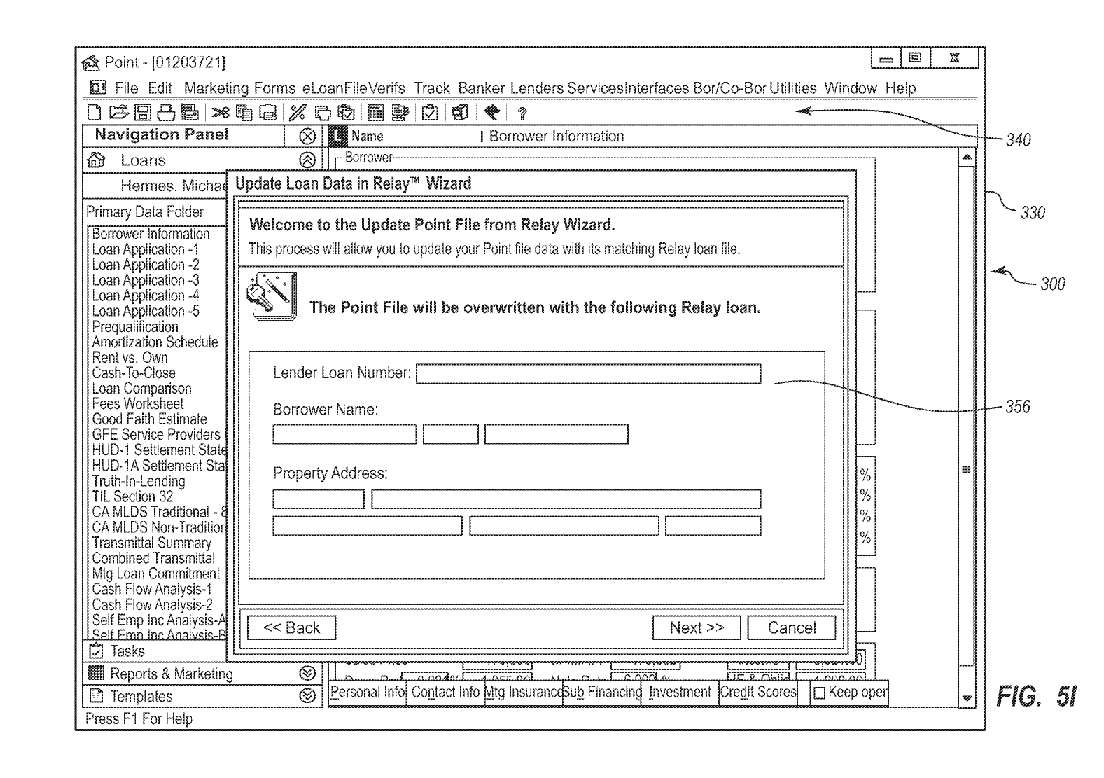

FIGS. 5A-5I are illustrations of screen shots of a display from an external bridging application system 300 showing the integration of the same POS activity application of FIGS. 4A-4B being embedded with its corresponding bridging application, in accordance with another embodiment of the present invention. In one aspect, the external bridging application 330 can be a separately executable software product which embeds the POS activity application as a process object within the bridging application. An example of the bridging application is the RELAY CONDUCTOR™ software program recently developed by Blueberry Systems, LLC of Greenwood Village, Colo.

In some respects the screen shots in FIGS. 5A-5I may be indicative of the completion of a single stage 104 in a work process 110 as implemented by the external bridging application systems 100 or 101 illustrated in FIG. 1 or FIG. 2, respectively, or of the method 200 outlined in FIG. 3. It is to be appreciated that while the work process illustrated in FIGS. 5A-5I is directed to a representative loan application work process, the embodiments of the present invention illustrated in FIGS. 1-3 and 5A-5I are nevertheless intended to represent any work process supported by one or more activity applications and bridging applications.

Starting with FIG. 5A, access to a bridging application 330/activity application 340 through a normal Windows Explorer® interface 302 is shown. FIG. 5B illustrates how a login ID box 304 can be provided during the launching of the bridging application 330, so as to better control access to the bridging application 330 and the activity application 340 embedded therein, and to limit a user's access to the activity data associated with a particular login ID.

Continuing with the example provided above, the work process shown in FIGS. 5A-5I illustrate the multiple steps or activities which may be followed in creating or updating a new loan application using the stand-alone POS activity application 310 shown in FIGS. 4A-4B.

Referring now to FIG. 5C, once the bridging application has been launched, the user accesses the embedded or “conducted” POS activity application 340 through a windowed interface of the bridging application 330, even though the user is seemingly interfacing directly with the activity application 340. In doing so, the original set of function controls of the stand-alone activity program can be changed or modified by the bridging application. FIG. 5C illustrates how the bridging application 330 can turn OFF various features in the original set of function controls that are available in the stand-alone instance of the POS activity application 310, as shown in FIGS. 4A-4B.

For example, the option to create a new loan 318 and the set of application-specific file management commands 314 in the stand-alone instance 310 of the POS activity application shown in FIG. 4A are removed in the embedded instance of the POS activity application 340 shown in FIG. 5B. In addition, the search command interface 316 in FIG. 4A has been changed to a different window 346 in FIG. 5C having a more limited set of options for accessing loan information for a particular account.

FIG. 5D serves to illustrate that the available options in the Primary Data Folder window 344 can include additional information about a specific loan application which was not available in the stand-alone instance of the activity program.

FIG. 5E illustrates how the shortcut for creating a new loan has also been removed from the FILE drop-down menu 348 for the embedded instance of the activity application 340. Instead, as shown in FIG. 5F, the bridging application 330 can add a “new loan” function control in the form of a pop-up wizard window 350, and in which the “new loan” feature is supported by the bridging application 330 and not the embedded activity application 340. In that manner, the external bridging application system 300 is able to control how new loans are created, in order to ensure better compatibility with other stages in the work process, and/or with other applications used to implement or compete the other stages in the work process.

FIG. 5G further illustrates how activity information generated in the embedded instance of activity application 340 may be used by other applications, and how the bridging application 330 can add additional functional controls and features to the embedded instance of the activity application 340. In the external bridging application system 300 illustrated in FIG. 5F, however, the bridging application 330 can modify the function controls of the activity application 340 by adding access to a second application. Furthermore, because the activity information may be stored in a core database using a common format, the activity information entered into the core database through the external bridging application system 300 can also be used by the other accessed application.

For instance, in the stand-alone instance of the activity application 310 illustrated in FIGS. 4A-4B, there may be no feature or capability for viewing how the loan application is progressing through the loan application process (e.g. work process). However, with the external bridging application system 300 illustrated in FIG. 5G supporting the loan application process as described above, a mortgage broker who would like to track the status of a loan application can open a new function control provided by the bridging application 330, such as a loan conditions/status window 352, from within the embedded activity application 340 to check on the status of the loan. The information provided in the loan conditions/status window 354 can be accessed from the core database using the bridging application 330.

FIG. 5H serves to illustrate the exporting of information generated by the embedded activity application 340 into the core database. This process can be initiated from within the activity application 340 and controlled through the bridging application 330. As such, as soon as the user completes a particular step or activity within a stage of the work process, the bridging application 330 operates to control the delivery of information to the core database through a pop-up window containing a data processing/export wizards 354. This wizard can convert the activity data from the native format used by the activity program 340 to the common or universal format used by the core database. In addition, the user can request to export the information to the core database at any time, rather than waiting until the particular step or activity is complete.

In another aspect of the invention illustrated in FIG. SI, an import wizard 356 also provided by the bridging application 330 may be used to convert the activity data from the common or universal format used by the core database to the native format used by the activity program 340.

### Internal Bridging Application System and Method

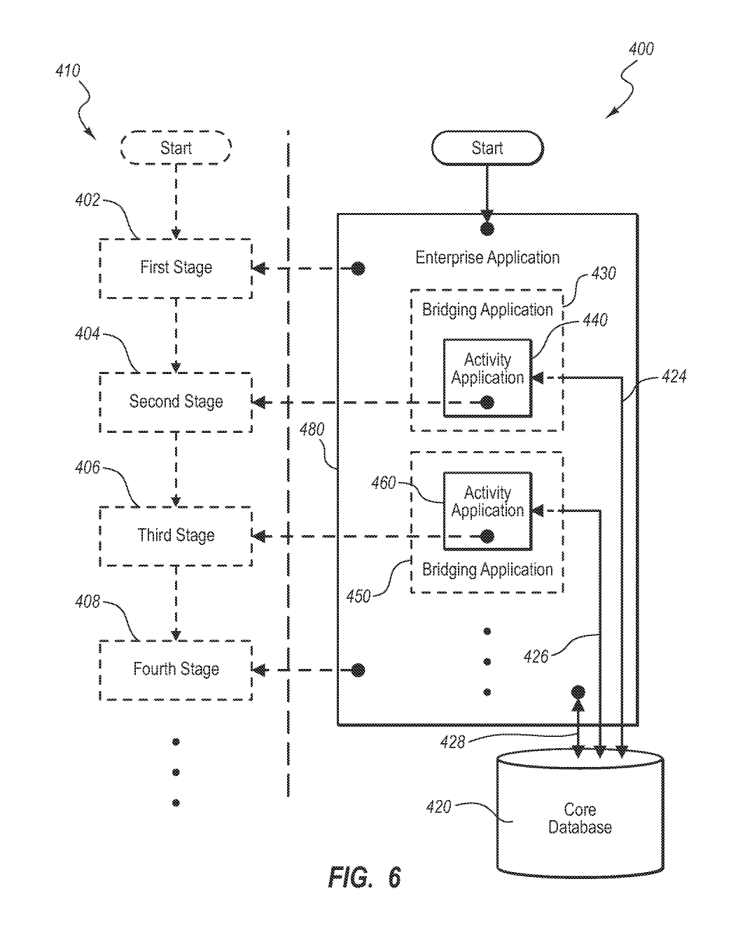

FIG. 6 is an illustration of an internal bridging application system 400 that includes one or more bridging applications embedded within an enterprise application, with each bridging application dedicated to an embedded activity application. At its core, the internal bridging application system 400 allows different applications to communicate with each other. The internal bridging application system 400 is unique in that one or more activity applications 440, 460 are embedded/integrated within one enterprise application 480. This is different from the external bridging application systems 100, 101 illustrated in FIGS. 1-2, respectively, where the activity applications 140, 160 act independently of the other and the bridging applications 130, 150 provide integration with a core database 120.

As shown in FIG. 6, the system 400 includes a work process 410 comprising a plurality of stages to be performed. As previously described, the work process 410 includes one or more stages that are completed in order to fulfill a business need. For instance, within the mortgage industry, the various stages may include taking in a loan application as a first stage, processing the loan as a second stage, performing customer retention as a later stage, etc. By way of illustration, the work process and its representative stages are shown to the left of the bolded line in FIG. 6, including a first stage 402, a second stage 404, a third stage 406 and a fourth stage 408 of an indeterminate amount of stages.

In many industries, a separate software application is created to perform the steps or activities in each of the stages. The internal bridging application system 400 allows for different applications that are incompatible to communicate and exchange information with each other. That is, a best-of-breed solution is provided within system 400 that allows the best activity application for a particular stage to be used, with full integration of each of the activity applications within the work process.

The internal bridging application system 400 includes an enterprise application 480 for supporting the implementation of the work process 410. The enterprise application 480 acts as the primary application which is capable of completing at least one of the stages or activities. Typically, the enterprise application 480 is used to support the implementation or completion of the majority of the stages in the work process 410, or is used to implement or complete the more important stages in the work process. As such, the enterprise application 480 is used to control and support the overall implementation and completion of the work process 410. One example of an enterprise application for use in the mortgage lending industry is the RELAY™ software program sold by Blueberry Systems, LLC of Greenwood Village, Colo.

In keeping with the loan production example provided above, the enterprise application 480 can be used to control most of the stages within a loan production process used within the mortgage industry. However, there are some stages 404, 406 in the typical loan production process where either the customer would prefer to use another third party software application to support the completion of those stages, or that the enterprise application 480 does not support. As such, third party software applications, or activity applications 440, 460 are often used to support the completion and/or implementation of those stages. In these situations, the third party applications may not be compatible with the enterprise application 480 being used to implement the work process. However, the internal bridging application system 400 is able to integrate those third party applications within the enterprise application 480, such that the activity information generated in any of the activity applications 440, 460 can be shared with all other applications and with a core database 420.

As shown in FIG. 6, the process of implementing the work process 410 begins by engaging the enterprise application 480. For instance, the enterprise application 480 may be used to support completion of the first stage 402 of the work process. The enterprise application may also be used to support the completion of other stages in the work process, such as the fourth stage 404.

Internal bridging application system 400 includes a first activity application 440 used to support completion or implementation of a corresponding stage 404 in the plurality of stages. As shown in FIG. 6, the first activity application 440 is in line with the second stage 404 of the work process to signify their relationship. In the example provided above, the first stage 402 may be the loan application process, and is used to gather personal and financial information about the borrowers. The second stage 404 may be loan processing or the loan production process, where a bank or other lender is found to fund the loan.

System 400 also a first bridging application 430 for providing access to the first activity application 440, by embedding the first activity application 440 within the enterprise application 480. The first bridging application 430 facilitates communication between the enterprise application 480 and the first activity application 440, wherein all communication with the first activity application 440 is conducted through the enterprise application 480 and the first bridging application 430. For instance, the first bridging application 430 reformats information delivered to the first activity application 440 from the enterprise application 480 into a format supported by the first activity application 440. Also, the first bridging application reformats information delivered from the first activity application 440 to the enterprise application 480 into a format supported by the enterprise application, such as a common or universal format.

Within the enterprise application 480, the first activity application 440 resides in modified form. That is, since the first activity application 440 is embedded within the enterprise application 480, various features or function controls of the first activity application 440 may be accessible, while other features are rendered inaccessible, or turned OFF. In this manner, the first activity application 440 need not be fully turned on, and only those features selected to support completion of the work process 410 in the first activity application 440 need to be accessed and turned ON. More specifically, the first bridging application 430 is able to customize the first activity application 440 in a manner that is consistent or congruent with accomplishing the work process 410. As such, the first bridging application 430 is able to turn OFF various features within the first activity application 440, and to add new features to the first activity application 440 that otherwise would not be available to the user, or to add new features in substitution of featured previously rendered unusable.

The first activity application 440 is embedded within the enterprise application 480. In one implementation, the first activity application 440 is accessed through a window that is overlaid the enterprise application on a display that provides one or more interfaces into both the enterprise and the activity applications.

Internal bridging application system 400 can include a second activity application 460 used to support completion or implementation of a corresponding stage in the plurality of stages. As shown in FIG. 6, the second activity application is in line with the third stage 406 of the work process to signify their relationship. In the example provided above, the first stage 402 may be the loan application process, used to gather personal and financial information about the borrowers, the second stage 404 may be loan processing or a loan production process, where a bank or other lender is found to fund the loan, and the third stage 406 may be a document preparation application used for closing the loan.

Internal bridging application system 400 can also include the second bridging application 450 for providing access to the second activity application 460, by embedding the second activity application 460 within the enterprise application 480. The second bridging application 450 facilitates communication between the enterprise application 480 and the second activity application 460, wherein all communication with the second activity application 460 is conducted through the enterprise application 480 and the second bridging application 450. For instance, the second bridging application 450 reformats information delivered to the second activity application 460 from the enterprise application 480 into a format supported by the second activity application 460.

Equally applicable to the second activity application 460, within the enterprise application 480 the second activity application 460 can reside in modified form. That is, since the second activity application 460 is embedded within the enterprise application 480, various features of the second activity application 460 may be accessible, while other features are rendered inaccessible, or turned OFF through the second bridging application 450. In this manner, the second activity application 460 need not be fully turned on, and only those features selected to support completion of the work process 410 in the second activity application 460 need to be accessed and turned ON, and new features may be added to the second activity application 460 that otherwise would not be available to the user, or to add new features in substitution of featured previously rendered unusable.

As described above, the bridging applications 430, 450 are able to communicate directly with their respective embedded activity applications 440, 460, since the bridging applications 430, 450 understand the commands, objects, and procedures, etc., used by their respective embedded application. For instance, a process may be implemented to discover the necessary information used to communicate with the embedded activity applications 440, 460 that involve using at least one API of a particular operating system for discovering information necessary for communicating with the embedded application.

Also shown in FIG. 6 is a core database 420 in communication with the enterprise application 480 for storing information or activity data 428 from the enterprise application 480 and the one or more activity applications 440, 460 embedded within the enterprise application. The information stored in the core database 420 may be usable or shared by both the enterprise application 480 and the activity applications 440, 460 embedded within the enterprise application 480.

For instance, the bridging applications 430, 450 take information from their respectively supported activity applications 440, 460, such as activity data 424, 426, and reformat that information into a common format, and thereafter deliver the activity data 424, 426 to the core database 420 for storage. The common format may be a format that is native to the enterprise application 480. In addition, the bridging applications 430, 450 can take information from the enterprise application to be delivered to a corresponding activity application and reformat that information from the common format into the format supported by that activity application. That information is then delivered to the activity application.

The core database 420 stores information in a common format so that the various applications 440, 460, 480 may access that information for their use. The information may be needed by the various applications supporting a work process. Rather than having each of the applications store that shared information in its own dedicated storage, the core database 420 provides a central repository for storing the shared information. As described previously, each of the applications may still store information critical to their operation, including shared information, within their own dedicated data store. While the various applications 440, 460, 480 may be incompatible with each other, in that they are unable to directly pass along information between themselves, by storing the information in a common format, the bridging applications are able to convert information provided in the common format to a corresponding format compatible with each of the activity applications 440, 460 requesting the information.

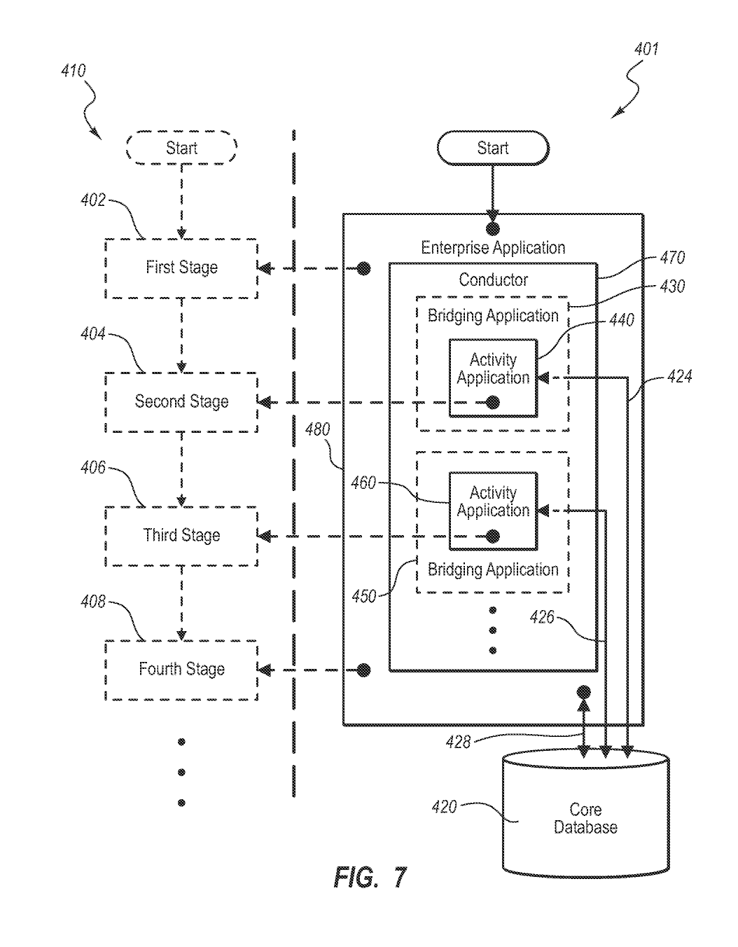

FIG. 7 is an illustration of an internal bridging application system 401 including one or more bridging applications 430, 450, each of which is dedicated to supporting or embedding a corresponding activity application 440, 460 within the an enterprise application 480, and which combined are capable of integrating the activity applications 440, 460 within a work process 410, in accordance with yet another embodiment of the present invention. The internal bridging application system 401 operates similarly to system 400 of FIG. 6 and the discussion describing system 400 is applicable to system 401; however, in addition to each activity application 440, 460 being accessible through its corresponding and dedicated bridging application 430, 460, respectively, an additional conductor layer 470 can also be provided as another pathway for conducting information directly between the first bridging application 430 and the second bridging application 450, and between the first and second bridging applications 430, 450 and the enterprise application 480. This information pathway can be in addition to the information pathways 424, 426 which are shared between the activity applications 440, 460 and the core database 420 through their respective bridging applications 430, 450, as well as the information pathway 428 which is shared between core database 120 and the enterprise application 480.

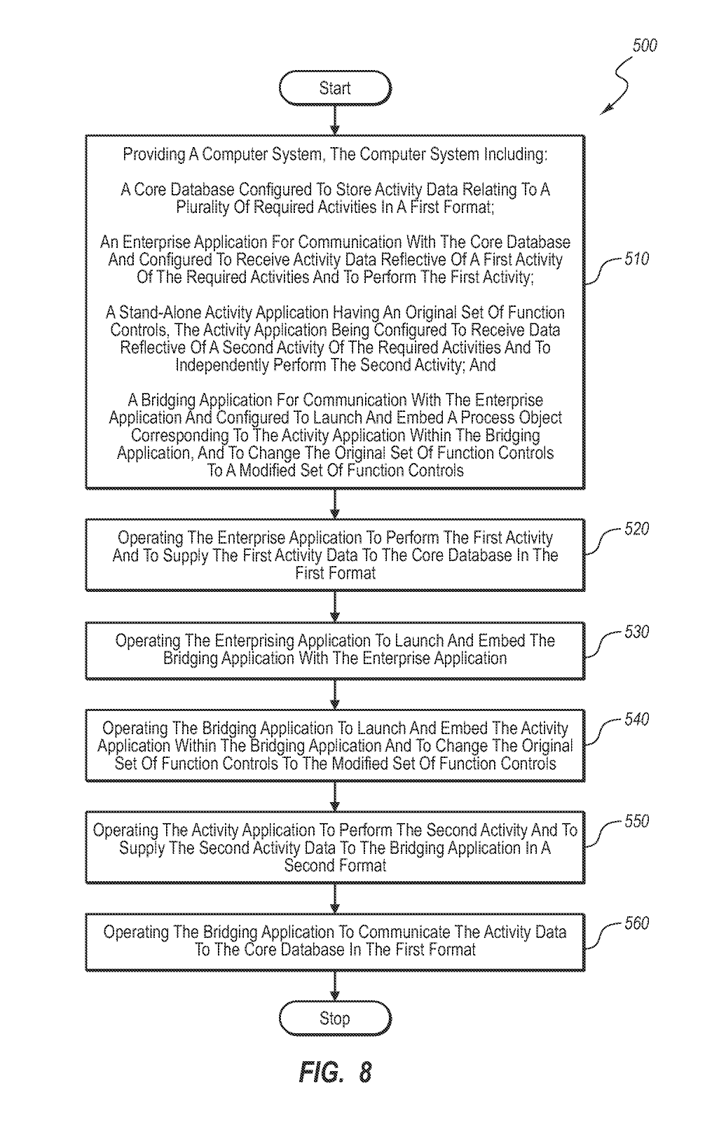

FIG. 8 is an illustration of a flow diagram illustrating a method 500 for implementing a work process having a plurality of required activities with an internal bridging application system that is used for integrating one or more activity applications with an enterprise application, in accordance with another embodiment of the present invention. In one aspect, the method of FIG. 8 can be implemented within the internal bridging application systems 400 and 401 of FIG. 6 and FIG. 7, respectively. Embodiments of the present invention allow for the various stages in a work process to be completed in a sequential order, a non-linear order, a random order, simultaneously where multiple stages are performed simultaneously, or a combination of the above.

As shown in FIG. 8, the method 500 includes providing 510 a computer system that includes a core database configured to store activity data relating to the plurality of required activities in a first format, an enterprise application for communication with the core database and configured to receive activity data reflective of a first activity of the required activities and to perform the first activity, a stand-alone activity application having an original set of function controls and being configured to receive activity data reflective of a second activity of the required activities and to independently perform the second activity, and a bridging application for communication with the enterprise application and configured to launch and embed a process object corresponding to the activity application within the bridging application, and to change the original set of function controls to a modified set of function controls.

The method 500 also includes operating 520 the enterprise application to perform the first activity and to supply the first activity data to the core database in the first format.

The method 500 further includes operating 530 the enterprise application to launch and embed a process object corresponding to the bridging application within the enterprise application.

The method 500 further includes operating 540 the bridging application to launch and embed a process object corresponding to the activity application within the bridging application and to change the original set of function controls to the modified set of function controls.

The method 500 further includes operating 550 the activity application to perform the second activity and to supply the second activity data to the bridging application in a second format different from the first format.

The method 500 further includes operating 560 the bridging application to communicate the second activity data to the core database in the first format.

In another embodiment of the method described above (not shown), a second stand-alone activity application is provided that is configured to receive activity data reflective of a third activity of the plurality of required activities and to independently perform the third activity, and which is also configured to supply third activity data reflective of the completion of the third activity in a third format different from the first format and the second format. For instance, the second application may provide document preparation, or client retention management, etc.

More specifically, the second activity application is embedded within the enterprise application through a second bridging application. The second bridging application provides access to the second application by facilitating communication between the enterprise application and the second activity application, and wherein all communication with the second activity application is conducted through the enterprise application and the second bridging application. For instance, the second bridging application reformats information delivered to the second activity application from the enterprise application into a format supported by the second activity application, and reformats information delivered to the enterprise application from the second activity application into a format supported by the enterprise application, such as the common format.

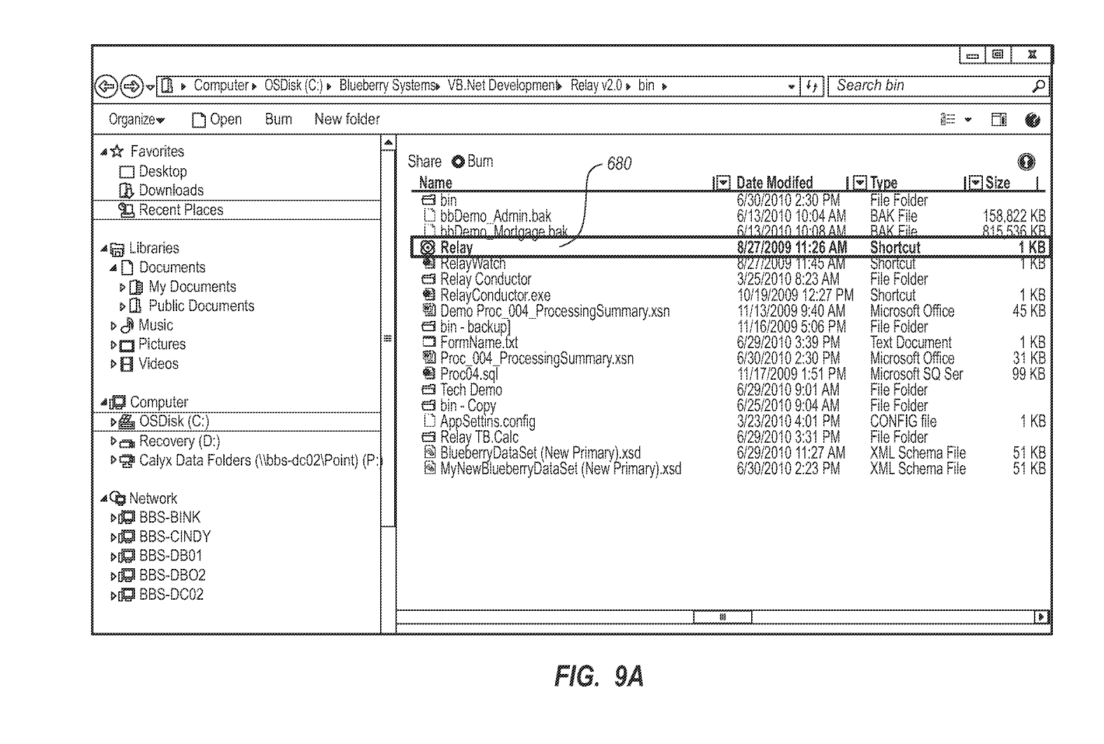

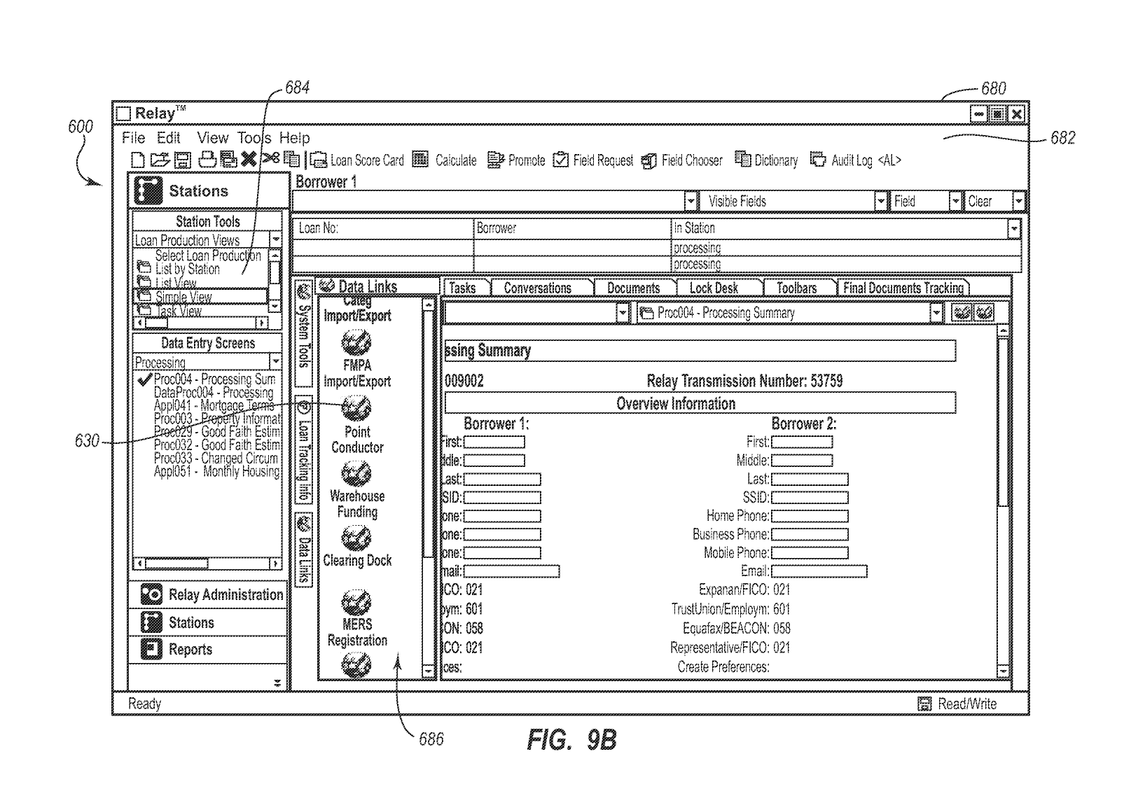

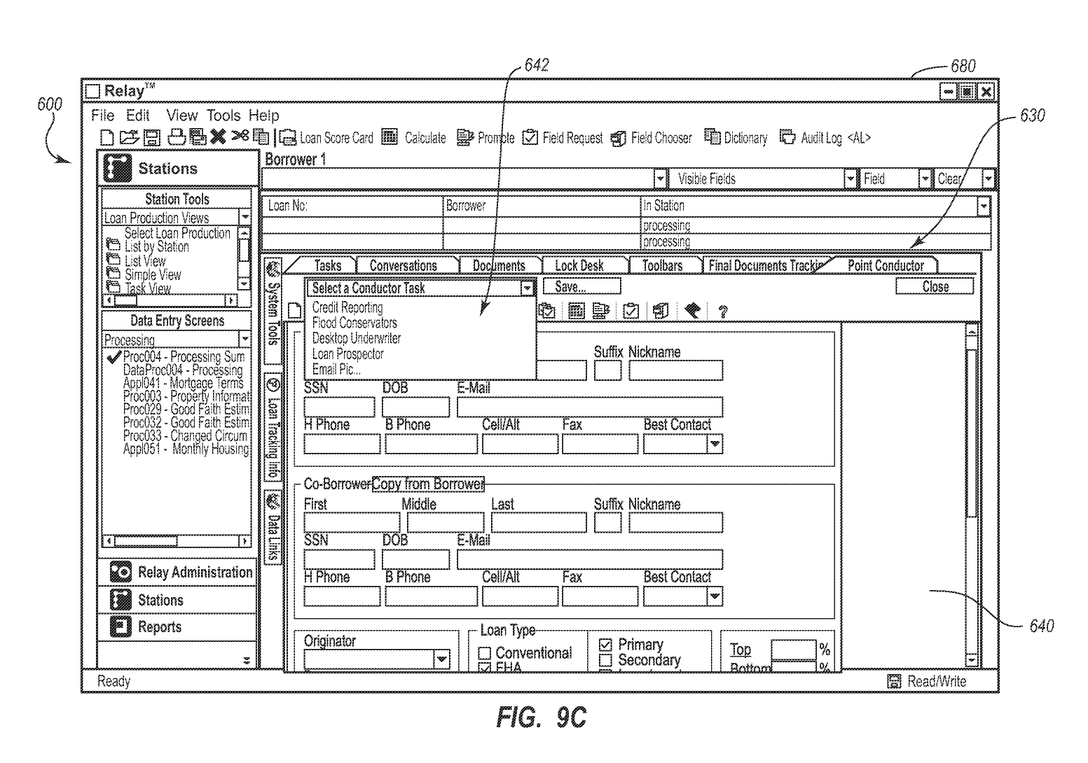

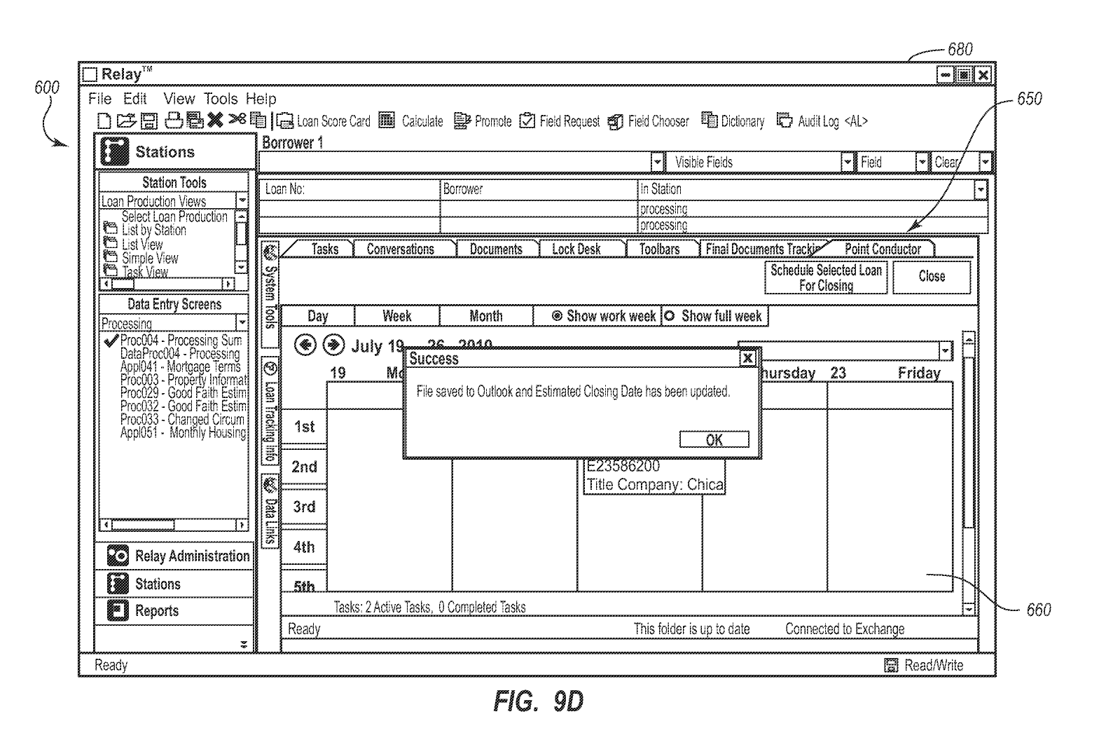

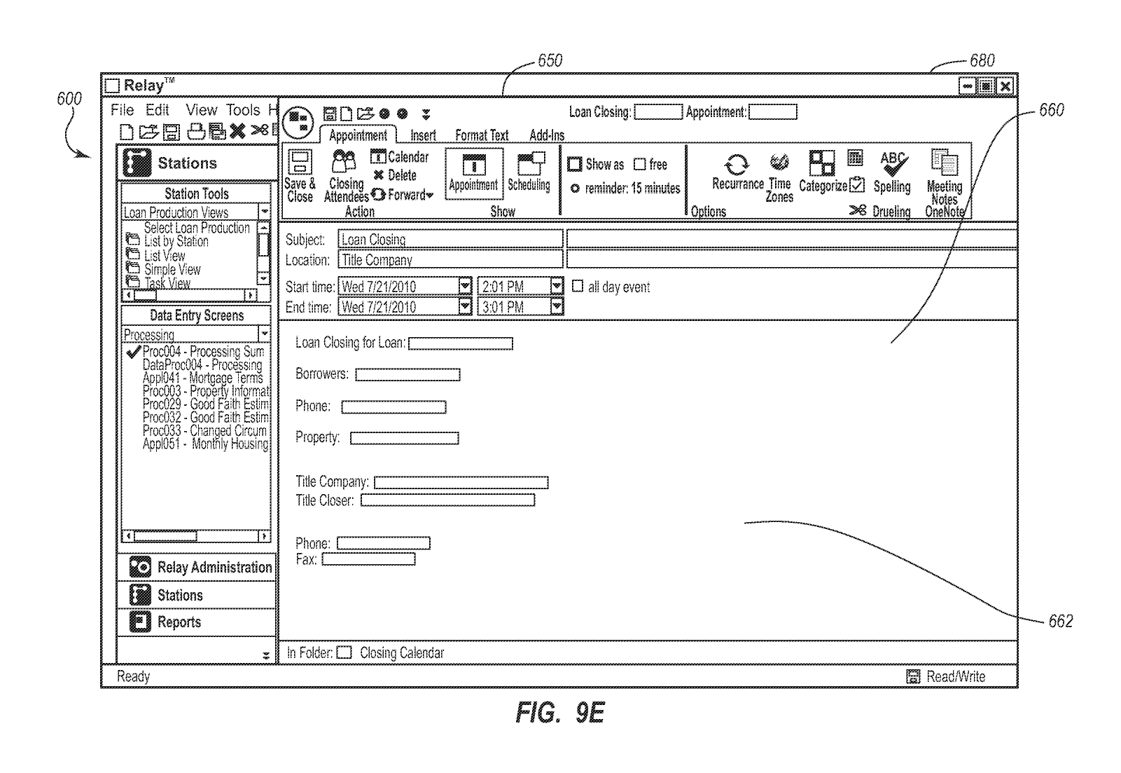

FIGS. 9A-9E are illustrations of screen shots of a display within an internal bridging application system showing the integration of representative activity applications and bridging applications within an enterprise application, in accordance with one embodiment of the present invention. The screen shots in FIGS. 9A-9E are indicative of the completion of the work process as implemented by system 400 of FIG. 6 and/or system 401 of FIG. 7, and/or the method outlined in FIG. 8. The work process illustrated in FIGS. 9A-9E is exemplary of a loan process related to the mortgage industry, but is intended to represent any work process supported by one or more applications.

Starting with FIG. 9A, access to the enterprise application 680 is shown. Specifically, the enterprise application can be used to control most of the stages within a loan application process used within the mortgage industry. While the enterprise application 680 provides some or most of the support in completing or implementing the work process, there are some stages that are supported by other third party applications, by preference of the customer, as will be described below. These third party applications are integrated within the enterprise application through one or more bridging applications, such that information generated in any of the applications is shared with all other applications, as previously described.

As shown in FIG. 9B, the enterprise application 680 includes a graphical display having a windowed interface 682 with multiple panes 684, 686, etc. In a first pane 684, for instance, a variety of station tools may be available. In a second pane 686, access to a plurality of data links can also be provided, at least one of which can be a bridging application 630 for launching and embedding a stand-alone activity program within the windowed interface 682 of the graphical display. Once launched, the embedded activity application can facilitate the creation of a new loan in a loan application process within the mortgage industry.

As shown in FIG. 9C, the embedded activity application 640 is accessed through the enterprise application 680 through the bridging application 630. As such, both the bridging application 630 and the activity application 640 are embedded with an inner pane 688 of the enterprise application. Furthermore, only those features or function control provided by the embedded bridging application 630 are accessible. As such, the bridging application 630 turns OFF various features in the embedded activity application 640, and only allows access to those features supporting the work process. For instance, in FIG. 9C, the following tasks 642 are available within the embedded activity program: Credit Reporting, Flood Certifications; Desktop Underwriter; Loan Prospector; Email File, etc.

As a result, the user is able to access the embedded activity application 640 without exiting the enterprise application 680. Rather than saving information created by the enterprise application, closing the enterprise application, opening the supporting stand-alone activity application, manually converting the information to a format supported by the stand-alone activity application, and then using that information in the stand-along activity application, the present method is able to integrate or embed the activity application 640 within the enterprise application 680 through the bridging application 630.

FIGS. 9D and 9E show another instance of integrating an embedded activity application 660 to schedule loan closings. As shown in FIG. 9D, an off the shelf e-mail and/or calendaring application 660 can be used in connection with a work process. In particular, a shared calendar feature is particularly important to the customer. Through this feature, multiple loan officers are able to schedule loan closings without conflicting with other closings, such as when only one closing can be handled at a particular time.

By using a bridging application 650 to embed a calendar application 660 within the enterprise application 680 that handles a loan application process, information gathered and created in the enterprise application 680, as well as with other embedded applications, can be then used by the calendar application 660. As such, within the enterprise application, by selecting the calendaring feature, all shared information relating to the loan application is imported via the bridging application 650 into the calendar application 660, as is shown in FIG. 9E. For instance, the borrowers name, other personal information, as well as loan information (e.g., loan number, title company) is immediately imported into the scheduling of a calendar event. The only new information needed to complete the calendar event is the time of the closing (e.g., Wednesday, 21 Jul. 2010 at 2:00 pm.

Accordingly, embodiments of the present invention provide for the integration of two or more applications within a best-of-breed solution used to implement a work process. Rather than choosing a cradle-to-grave solution, a customer is able to select applications to their own liking and integrate all of them within a single solution to support completion or implementation of a work process.

A system and method for integrating one or more applications for purposes of implementing a work process is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed is:

1. A computer system for performing a work process having a plurality of required activities, said computer system comprising:
a core database configured to store activity data reflective of said plurality of required activities, said core database being configured to receive and supply said activity data in a first format;
an enterprise application for communication with said core database, said enterprise application being configured to receive activity data reflective of a first activity of said plurality of required activities and to perform said first activity, said enterprise application being configured to supply first activity data reflective of the completion of said first activity to said core database in said first format,
an activity application which is a stand-alone executable program having an original set of function controls which are not congruent with said enterprise application, said activity application being configured to receive activity data reflective of a second activity of said plurality of required activities and to independently perform said second activity, said activity application being configured to supply second activity data reflective of the completion of said second activity in a second format different from said first format; and
a bridging application for communication with said enterprise application, said bridging application being configured to launch and embed a process object corresponding to said activity application within said bridging application, said bridging application being configured to change said original set of function controls into a modified set of function controls which are congruent with said enterprise application, said bridging application being in communication with said core database and configured to communicate said second activity data from said activity application to said core database.

2. The computer system of claim 1, wherein said enterprise application is configured to launch and embed a process object corresponding to said bridging application within said enterprise application.

3. The computer system of claim 2, wherein said enterprise application includes a graphical display having an inner pane of a windowed interface, said inner pane having both said bridging application and said activity application embedded therein.

4. The computer system of claim 1, wherein said bridging application is configured to receive said second activity data from said activity application in said second format, reformat said second activity data into said first format, and to deliver said second activity data to said core database in said first format.

5. The computer system of claim 1, wherein said bridging application is configured to receive said second activity data from said core database in said first format, reformat said second activity data into said second format, and to deliver said second activity data to said activity application in said second format.

6. The computer system of claim 1, wherein said modified set of function controls includes at least one additional function control not included in said original set of function controls.

7. The computer system of claim 1, further comprising:
a second activity application, said second activity application being a stand-alone executable program with a second original set of function controls which is not congruent with said enterprise application, said second activity application being configured to receive activity data reflective of a third activity of said plurality of required activities and to independently perform said third activity, said activity application being configured to supply third activity data reflective of the completion of said third activity in a third format different from said first format and said second format; and
a second bridging application in communication with said enterprise application, said second bridging application being configured to launch and embed a second process object corresponding to said second activity application within said second bridging application, said second bridging application being configured to change said second original set of function controls of second activity application to a second modified set of function controls which is congruent with said enterprise application, said second bridging application being in communication with said core database and configured to communicate said third activity data from said second activity application to said core database.

8. The computer system of claim 7, wherein said enterprise application is configured to launch and embed a process object corresponding to said second bridging application within said enterprise application.

9. The computer system of claim 8, said enterprise application includes a graphical display having an inner pane of a windowed interface, said inner pane having both said bridging application and said activity application embedded therein.

10. The computer system of claim 1, further comprising at least one application programming interface (API) for discovering information necessary for establishing communications between said bridging application and said activity application.

11. The computer system of claim 1, wherein said activity application is selected from the group consisting of a point-of-sale program and an e-mail program, said e-mail program having an event calendar module.

12. A method for implementing a work process having a plurality of required activities, said method comprising:
providing a computer system, said computer system including:
a core database configured to store activity data relating to said plurality of required activities, said core database being configured to receive and supply said activity data in a first format;
an enterprise application for communication with said core database; said enterprise application being configured to receive activity data reflective of a first activity of said plurality of required activities and to perform said first activity;
an activity application which is a stand-alone executable program having an original set of function controls which are not congruent with said enterprise application, said activity application being configured to receive activity data reflective of a second activity of said plurality of required activities and to independently perform said second activity; and
a bridging application for communication with said enterprise application, said bridging application being configured to launch and embed a process object corresponding to said activity application within said bridging application, said bridging application being configured to change said original set of function controls into a modified set of function controls which are congruent with said enterprise application;
operating said enterprise application to perform said first activity and to supply said first activity data to said core database in said first format;
operating said bridging application to launch and embed said activity application within said bridging application and to change said original set of function controls to said modified set of function controls;
operating said activity application to perform said second activity and to supply said second activity data to said bridging application; and
operating said bridging application to communicate said second activity data to said core database.

13. The method of claim 11, wherein said bridging application receives said second activity data from said activity application in said second format, reformats said second activity data into said first format, and delivers said second activity data to said core database in said first format.

14. The method of claim 11, wherein launching and embedding said activity application within said bridging application further comprises launching and embedding a process object corresponding to said bridging application within said enterprise application.

15. The method of claim 11, wherein changing said original set of function controls to said modified set of function controls includes adding at least one additional function control not included in said original set of function controls.

16. The method of claim 15, wherein said at least one additional function control comprises a process object embedded within said activity program.

17. The method of claim 15, further comprising operating said bridging application to communicate with said enterprise application and retrieve said first activity data from said enterprise application, and to supply said first activity data to said activity application through said at least one additional function control.

18. The method of claim 11, wherein operating said bridging application to launch and embed said activity application further comprises selecting from the group of activity programs consisting of a point-of-sale program and an e-mail program, said e-mail program having an event calendar module.

19. A method for implementing a work process having a plurality of required activities, said method comprising:
providing a computer system, said computer system including:
a core database configured to store activity data relating to said plurality of required activities, said core database being configured to receive and supply said activity data in a first format;
an activity application which is a stand-alone executable program having an original set of function controls, said activity application being configured to receive activity data reflective of a select activity of said plurality of required activities and to independently perform said select activity, said activity application being configured to supply select activity data reflective of the completion of said select activity in a second format different from said first format; and
a bridging application for communication with said core database, said bridging application being configured to launch and embed a process object corresponding to said activity application within said bridging application, said bridging application being configured to change said original set of function controls to a modified set of function controls;
operating said bridging application to launch and embed said activity application within said bridging application and to change said original set of function controls to said modified set of function controls;
operating said activity application to perform said select activity and to supply said select activity data to said bridging application in said second format; and
operating said bridging application to communicate said select activity data to said core database in said first format.

20. The computer system of claim 19, wherein said modified set of function controls includes at least one additional function control not included in said original set of function controls.
